(19) United States
(12) Patent Application Publication
(10) Pub. No.: US 2007/0270281 A1
(43) Pub. Date: Nov. 22, 2007

(54) VEHICLE START CONTROL DEVICE AND METHOD

(75) Inventors: Daisuke Inoue, Toyota-shi (JP); Hiroji Taniguchi, Okazaki-shi (JP)

Correspondence Address: SUGHRUE MION, PLLC, 2100 PENNSYLVANIA AVENUE, N.W., SUITE 800, WASHINGTON, DC, 20037, US

(73) Assignee: Toyota Jidosha Kabushiki Kaisha

(21) Appl. No.: 11/752,065

(22) Filed: May 22, 2007

(30) Foreign Application Priority Data
May 22, 2006 (JP) 2006-141555

(51) Int. Cl. B60W 10/02

(52) U.S. Cl. 477/180

(57) ABSTRACT

A vehicle start control device executes a neutral control and a hill hold control, wherein, in the neutral control, a clutch provided in a power transmission path is brought into a slipping state or a released state to reduce the engine idling load and in the hill hold control, a brake force is generated to hold the vehicle against movement on a hill. A neutral release mode controller is employed to increase a torque transfer capacity of the clutch so that the clutch is engaged more gently when the neutral control is released under the hill hold control than in case of releasing the neutral control when the hill hold control is not executed. This suppresses generation of a shock that would be caused by engagement of the clutch when the neutral control is released under the hill hold control.

### INCORPORATION BY REFERENCE

The disclosure of Japanese Patent Application No. 2006-141555 filed on May 22, 2006 including the specification, drawings, and abstract, is incorporated by reference in its entirety.

### BACKGROUND OF THE INVENTION

1. Field of the Invention

The present invention relates to a vehicle start control device and method that executes a neutral control and a hill hold control and, more particularly, that releases the neutral control.

2. Description of the Related Art

There is known a vehicle start control device that performs a neutral control and a hill hold control. In a neutral control, if predetermined neutral control conditions are satisfied while a shift position of a transmission is a drive position, e.g., if a foot brake is operated when the vehicle speed is zero, a coupling device provided in the power transmission path between the engine and the drive wheels is slipping or is released. Thus, the power transmission path is kept in a power transfer suppressing state to reduce an engine idling load. In a hill hold control, if predetermined hill hold control conditions are satisfied on a hill, e.g., if a vehicle is stopped with a road slope being equal to or greater than a predetermined value, a braking force is generated, independently of the operation of the foot brake, to keep the vehicle on the hill from moving.

One example of such a vehicle control device is described in Japanese Patent Publication No. JP-B-3301296. Japanese Patent Publication No. JP-B-3301296 teaches an automatic transmission control device that performs both the neutral control and the hill hold control. That is, an input clutch of a speed changing mechanism part is released, e.g., to improve fuel economy, when a vehicle is stopped in a forward drive range to keep the vehicle from rolling backward on an uphill, a hill hold brake is engaged so as to prevent any reverse rotation of an output rotation member that would be caused by releasing the input clutch.

In the vehicle control device that executes the neutral control and the hill hold control as described in Japanese Patent Publication No. JP-B-3301296, the wheels, i.e., the output rotation member of the transmission, may be rotated upon full engagement of the input clutch, insofar as the vehicle is in a normal state in which the hill hold control is not being executed, when the neutral control is released to start the vehicle. This reduces a torque reaction attributable to the engagement of the input clutch, thereby suppressing generation of an engagement shock. When the hill hold control is executed, however, the vehicle is held against movement not only in a backward direction but also in a forward direction. Thus, the wheels are not allowed to rotate when the input clutch is fully engaged. In other words, the output rotation member of the transmission remains fixed. This leaves a possibility that the torque reaction attributable to the engagement of the input clutch may not be reduced and the engagement shock may become greater than that generated in the normal state.

### SUMMARY OF THE INVENTION

The present invention provides a vehicle start control device and a vehicle start control method that execute a neutral control and a hill hold control, wherein in the neutral control, a coupling device provided in a power transmission path between an engine and drive wheels is brought into a slipping state or a released state to reduce an engine idling load and in the hill hold control, a brake force is generated in a vehicle to hold the vehicle against movement on a hill, to suppress generation of a shock which would be caused by engagement of the coupling device as the neutral control is released under the hill hold control.

Thus, a first aspect of the invention is directed to a vehicle start control device that executes the neutral control and the hill hold control, wherein in the neutral control, if predetermined neutral control conditions are satisfied in a drive position, a coupling device provided in a power transmission path between an engine and drive wheels is brought into a slipping state or a released state and thus the power transmission path is kept in a power transfer suppressing state to reduce an engine idling load; and, in the hill hold control, if predetermined hill hold conditions are satisfied on a hill, a brake force is generated in a motor vehicle to hold the motor vehicle on a hill against movement on the hill. The vehicle start control device includes a neutral release mode controller that increases the torque transfer capacity of the coupling device so that when the neutral control is released, the coupling device is engaged more gently while the hill hold control is being executed than when the hill hold control is not executed.

With the configuration described above, the torque transfer capacity of the coupling device is increased by the neutral release mode controller so that, when the neutral control is released, the coupling device can be engaged more gently when the hill hold control is being executed than when the hill hold control is not executed. Therefore, it possible to suppress generation of a shock, which would be caused by engagement of the coupling device, when the neutral control is released under the hill hold control.

Furthermore, a drive feel can be improved by suppressing generation of a shock in this way. Thus, it becomes possible to execute the neutral control with an increased chance of execution and to reduce the fuel consumption rate, even under a running state accompanying the hill hold control in which deterioration of a drive feel is likely to occur and thus there is a tendency to avoid the neutral control for that reason, e.g., under a state that a motor vehicle is stopped on a steep uphill with accompanying execution of the hill hold control.

A second aspect of the invention is similar to the vehicle start control device of the first aspect, wherein the neutral release mode controller engages the coupling device by gradually increasing a torque transfer capacity of the coupling device, and wherein, in gradually increasing the torque transfer capacity of the coupling device, the neutral release mode controller reduces an increment gradient of the torque transfer capacity under the hill hold control more than that when the hill hold control is not executed. With this configuration, the torque transfer capacity in the engagement process of the coupling device can be gradually increased with a smaller value in case of execution of the hill hold control than in case of non-execution of the hill hold control. Therefore, it possible to release the neutral control and suppress engagement shock which would be generated at the time of releasing the neutral control.

A third aspect of the invention is similar to the first aspect, except that the neutral release mode controller engages the coupling device by gradually increasing the torque transfer capacity of the coupling device, and wherein, in gradually increasing the torque transfer capacity of the coupling device, the neutral release mode controller reduces the magnitude of the torque transfer capacity under the hill hold control more than that when the hill hold control is not executed. With this configuration, the torque transfer capacity in the engagement process of the coupling device is gradually increased with a smaller value under the hill hold control than that when the hill hold control is not executed. Therefore, it possible to release the neutral control and suppress engagement shock which would be generated at the time of releasing the neutral control.

A fourth aspect of the invention is similar to the first aspect, except that the neutral release mode controller increases the torque transfer capacity of the coupling device in such a manner that, when the hill hold control is terminated during the course of releasing the neutral control, the coupling device is engaged more rapidly than in case of the hill hold control. With this configuration, as compared to when the coupling device is not rapidly engaged, it is easier to obtain the required start torque, while relieving an unintentional behavior of a motor vehicle which would occur as the bill hold control is terminated.

A fifth aspect of the invention is similar to the fourth aspect, except that the neutral release mode controller engages the coupling device by gradually increasing the torque transfer capacity of the coupling device, wherein, in gradually increasing the torque transfer capacity of the coupling device, the neutral release mode controller controls an increment gradient of the torque transfer capacity to be substantially equal to that when the hill hold control is not executed. With this configuration, the torque transfer capacity when engaging the coupling device is rapidly increased to assure rapid engagement of the coupling device, and the torque transfer capacity when engaging the coupling device is gradually increased with a smaller value than that when the hill hold control is not executed. Therefore, it possible to release the neutral control and suppress engagement shock which would be generated at the time of releasing the neutral control.

A sixth aspect of the invention is similar to the fourth aspect, except that the neutral release mode controller engages the coupling device by gradually increasing the torque transfer capacity of the coupling device, and wherein, in gradually increasing the torque transfer capacity of the coupling device, the neutral release mode controller controls a magnitude of the torque transfer capacity to be substantially equal to that when the hill hold control is not executed. With this configuration, the torque transfer capacity in the engagement process of the coupling device is rapidly increased to thereby assure rapid engagement of the coupling device, and the torque transfer capacity in the engagement process of the coupling device is gradually increased with a smaller value than that when the hill hold control is not executed. Therefore, it possible to release the neutral control and suppress engagement shock which would be generated at the time of releasing the neutral control.

A seventh aspect of the invention is directed to the vehicle start control device of the first aspect, wherein, when the hill hold control is terminated during releasing the neutral control, the neutral release mode controller increases a torque transfer capacity of the coupling device in a different manner from the case of the hill hold control. With this configuration, it is possible to effectively suppress or relieve the behavior of a motor vehicle which would be caused by a change when the hill hold control is terminated.

A eighth aspect of the invention is similar to the seventh aspect, but differs in that the neutral release mode controller engages the coupling device by gradually increasing the torque transfer capacity of the coupling device, the neutral release mode controller changes the increment gradient of the torque transfer capacity in gradually increasing the torque transfer capacity of the coupling device. With this configuration, the torque transfer capacity in the engagement process of the coupling device is gradually increased with a smaller value than that when the hill hold control is not executed. Therefore, it is possible to release the neutral control and suppress engagement shock which would be generated at the time of releasing the neutral control.

A ninth aspect of the invention is similar to the eighth aspect, except that in gradually increasing the torque transfer capacity of the coupling device, the neutral release mode controller allows the increment gradient of the torque transfer capacity to be equal to the median value of an increment gradient available under the hill hold control and that when the hill hold control is not executed. With this configuration, it is possible to effectively suppress or relieve the behavior of a motor vehicle which would be caused by a change when the hill hold control is terminated.

A tenth aspect of the invention is similar to the vehicle start control device of the seventh aspect, except that the neutral release mode controller engages the coupling device by gradually increasing the torque transfer capacity of the coupling device, the neutral release mode controller changes a magnitude of the torque transfer capacity in gradually increasing the torque transfer capacity of the coupling device. With this configuration, the torque transfer capacity in the engagement process of the coupling device can be gradually increased with a smaller value than that when the hill hold control is not executed. Therefore, it possible to release the neutral control and suppress engagement shock which would be generated at the time of releasing the neutral control.

A eleventh aspect of the invention is similar to the tenth aspect, except that in gradually increasing the torque transfer capacity of the coupling device, the neutral release mode controller allows the magnitude of the torque transfer capacity to be equal to the median value of a magnitude of the torque transfer capacity available under the hill hold control and that when the hill hold control is not executed. With this configuration, it is possible to effectively suppress or relieve the behavior of a motor vehicle which would be caused by a change when the hill hold control is terminated.

A twelfth aspect of the invention is directed to a vehicle start control method for conducting neutral control and hill hold control, wherein, in the neutral control, if predetermined neutral control conditions are satisfied in a drive position, a coupling device provided in a power transmission path between an engine and the drive wheels is brought into a slipping state or a released state and thus the power transmission path is kept in a power transfer suppressing state to reduce an engine idling load and, in the hill hold control, if predetermined hill hold control conditions are satisfied on a hill, a brake force is generated in a motor vehicle to hold the motor vehicle against movement on the hill. The method includes increasing a torque transfer capacity of the coupling device in such a manner that the coupling device is engaged more gently in case of releasing the neutral control under the hill hold control than in case of releasing the neutral control when the hill hold control is not executed.

A thirteenth aspect of the invention is similar to the twelfth aspect, except that the torque transfer capacity may be increased by gradually increasing the torque transfer capacity of the coupling device and an increment gradient of the torque transfer capacity under the hill hold control is reduced more than that when the hill hold control is not executed.

A fourteenth aspect of the invention is similar to the twelfth aspect, except that the torque transfer capacity may be increased by gradually increasing the torque transfer capacity of the coupling device and the magnitude of the torque transfer capacity under the hill hold control is reduced more than that when the hill hold control is not executed.

A fifteenth aspect of the invention is similar to the twelfth aspect, except that the torque transfer capacity may be increased by increasing the torque transfer capacity of the coupling device in such a manner that, when the hill hold control is terminated during releasing the neutral control, the coupling device is engaged more rapidly than under the hill hold control.

A sixteenth aspect of the invention is similar to the fifteenth aspect, except that the torque transfer capacity may be increased by gradually increasing the torque transfer capacity of the coupling device and an increment gradient of the torque transfer capacity is equal to that when the hill hold control is not executed.

A seventeenth aspect of the invention is similar to the fifteenth aspect, except that the increasing the torque transfer capacity includes gradually increasing the torque transfer capacity of the coupling device, wherein, when gradually increasing the torque transfer capacity of the coupling device, the magnitude of the torque transfer capacity is equal to that when the hill hold control is not executed.

An eighteenth aspect of the invention is similar to the twelfth aspect except that the increasing of the torque transfer capacity includes gradually increasing the torque transfer capacity of the coupling device and changing an increment gradient of the torque transfer capacity in the gradually increasing the torque transfer capacity of the coupling device.

A nineteenth aspect of the invention is similar to the eighteenth aspect, except that the increment gradient of the torque transfer capacity, in the gradually increasing the torque transfer capacity of the coupling device, is equal to the median value of an increment gradient under the hill hold control and that when the hill hold control is not executed.

A twentieth aspect of the invention is similar to the eighteenth aspect, except that the magnitude of the torque transfer capacity, in the gradually increasing the torque transfer capacity of the coupling device, is equal to the median value of a magnitude of the torque transfer capacity available under the hill hold control and that when the hill hold control is not executed.

The automatic transmission may be provided in a power transmission path between an engine and drive wheels. Example automatic transmissions include: a variety of planetary gear type multiple speed transmission in which rotating elements of a plurality of planetary gear sets are selectively connected to accomplish one of a plurality of speed ratios, e.g., four forward drive speed ratios, five forward drive speed ratios, six forward drive speed ratios and even greater speed ratios; a synchronously engaged parallel dual shaft type automatic transmission that has plural pairs of constantly engaging shift gears arranged on a couple of shafts, one of the plural pairs of shift gears being alternatively brought into a power transferring condition by means of a synchronizing device driven by a hydraulic actuator or the like, whereby shift speed ratios are shifted automatically; a belt type continuously variable transmission in which a power transmission belt serving as a power transfer member is wound around a pair of pulleys with variable effective diameters so that speed ratios can be changed continuously in a stepless manner; a toroidal type continuously variable transmission that has a pair of cone members rotating about a common axis and a plurality of rollers rotatable about rotational axes intersecting the common axis, the rollers being sandwiched between and pressed by the cone members so that speed ratios are continuously changed depending upon the change in an intersecting angle between the rotational axes of the rollers and the common axis; and an automatic transmission, e.g., a drive apparatus for hybrid cars serving as an electric stepless transmission, that includes a differential mechanism consisting of, e.g., a planetary gear unit for distributing an engine power to a first electric motor and an output rotation member, and a second electric motor attached to the output rotation member of the differential mechanism, the differential mechanism performs a differential action in such a fashion that the majority of the engine power is mechanically transmitted to drive wheels and the remainder of the engine power is electrically transmitted to the drive wheels through an electric path extending from the first electric motor to the second electric motor, thereby changing speed ratios electrically. These automatic transmissions may be used independently or in combination.

The automatic transmission may be transversely mounted on a front engine front drive (FF) vehicle so that the axis thereof extends in a vehicle width direction or may be longitudinally mounted on a front engine rear drive (FR) vehicle so that the axis thereof extends in a vehicle length direction.

The coupling device disposed on the power transmission path between the engine and the drive wheels may be brought into a slipping state or a released state when the neutral control is executed to keep the power transmission path in a power transfer suppressing condition. A coupling device that keeps a planetary gear type multiple ratio transmission in a neutral state may be used if the automatic transmission is composed of the planetary gear type multiple ratio transmission. In addition, a coupling device that disconnects power input from the engine to the automatic transmission or that disconnects power output from the automatic transmission to the drive wheels may be used if the automatic transmission has no coupling device for keeping the transmission in a neutral condition.

A hydraulically operated friction coupling device such as a multiple disc clutch, a single disc clutch or the like may be used as the coupling device. An oil pump that supplies working fluid for engaging the hydraulically operated friction coupling device may be, e.g., of the type driven by an engine to discharge the working fluid or of the type driven by a dedicated electric motor provided independently of the engine. In addition to the hydraulically operated friction-coupling device, an electromagnetic coupling device, e.g., an electromagnetic clutch or a magnetic powder type clutch may be used as the coupling device.

An internal combustion engine such as a gasoline engine, a diesel engine or the like may be used as the engine noted above.

The phrase “supplies fluid pressure” or its equivalent used herein means that fluid pressure is exerted against something or working fluid controlled under that fluid pressure is supplied to something.

### BRIEF DESCRIPTION OF THE DRAWINGS

The above and other objects and features of the present invention will become apparent from the following description of preferred embodiments, given in conjunction with the accompanying drawings, in which:

FIG. 1 is a schematic diagram showing a configuration of an automatic transmission for motor vehicles to which the present invention applies;

FIG. 2 is an operation table illustrating different operation combinations of friction-coupling devices when establishing a plurality of speed ratios in the automatic transmission for motor vehicles shown in FIG. 1;

FIG. 3 is a block diagram showing major parts of a control system provided in a motor vehicle for controlling the automatic transmission shown in FIG. 1 and a simplified configuration of a power transmission system extending from an engine to drive wheels;

FIG. 4 is a circuit diagram showing linear solenoid valves for controlling operations of individual hydraulic actuators of clutches and brakes in the hydraulic control circuit shown in FIG. 3;

FIG. 5 is a functional block diagram illustrating major function parts controlled by the electronic control unit shown in FIG. 3;

FIG. 6 is a view representing one example of a shift diagram used in shift control of the automatic transmission;

FIG. 7 shows one example of predetermined patterns of control signals (hydraulic command values) for increasing a clutch engagement pressure, which control signals are output to a hydraulic control circuit by means of a shift control means when a clutch is engaged to release neutral control, the single-dotted chain line representing a predetermined signal pattern at the time of non-execution of hill hold control and the solid line indicating a predetermined signal pattern at the time of execution of the hill hold control;

FIG. 8 is a flowchart explaining major control operations of the electronic control unit shown in FIG. 3, i.e., control operations for suppressing generation of a shock caused by engagement of a clutch at the time of releasing neutral control;

FIG. 9 is a timing chart explaining the control operations illustrated in the flowchart of FIG. 8;

FIG. 10 is a flowchart, which corresponds to FIG. 8 but pertains to a different embodiment, explaining major control operations of the electronic control unit shown in FIG. 3, i.e., control operations for suppressing generation of a shock caused by engagement of a clutch at the time of releasing neutral control; and

FIG. 11 is a view, which corresponds to FIG. 7 but pertains to a different embodiment, showing one example of predetermined patterns of control signals (hydraulic command values) for increasing a clutch engagement pressure, which control signals are output to a hydraulic control circuit by means of a shift control means when a clutch is engaged to release neutral control, the single-dotted chain line representing a predetermined signal pattern at the time of non-execution of hill hold control, the solid line indicating a predetermined signal pattern at the time of execution of the hill hold control.

### DETAILED DESCRIPTION OF THE PREFERRED EMBODIMENTS

Various embodiments of the present invention will now be described in detail with reference to the accompanying drawings.

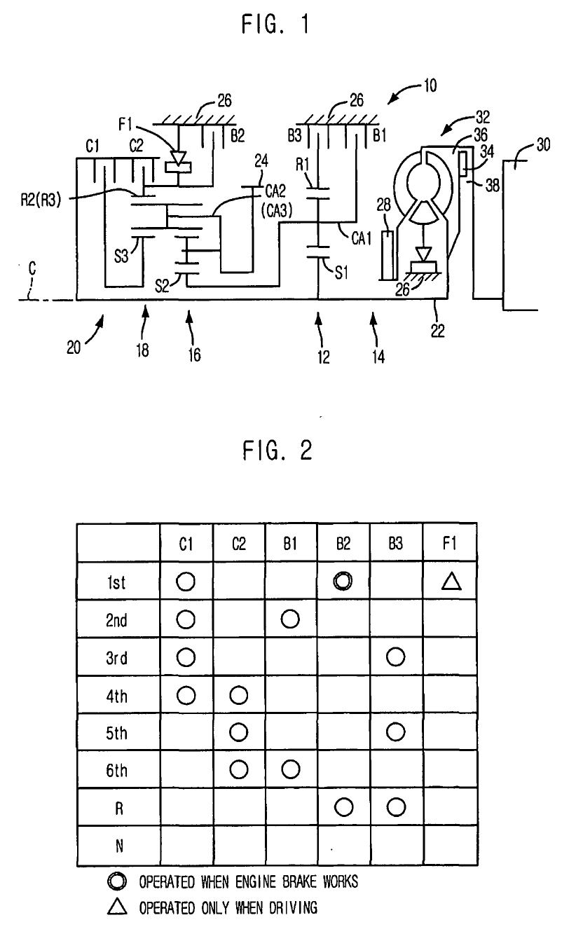

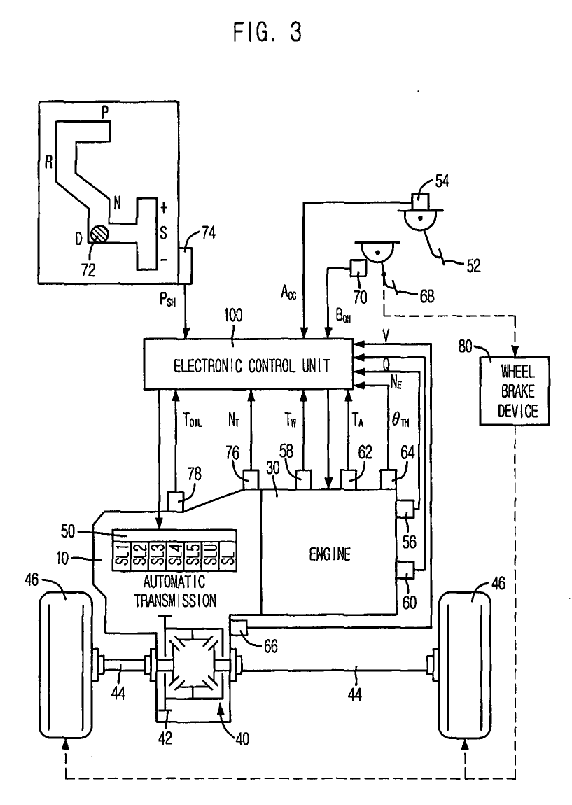

FIG. 1 is a schematic diagram showing an automatic transmission 10 for a motor vehicle (hereinafter simply referred to as “automatic transmission”). FIG. 2 is an operation table illustrating operation states of friction-coupling elements, i.e., friction-coupling devices, at different speed ratios. The automatic transmission 10 may be adapted for optimal use in a front-engine front-wheel drive (FF) vehicle in which the automatic transmission 10 is mounted transversely. The automatic transmission 10 includes a transmission case 26 that serves as a non-rotating member fixed to the vehicle body; a first transmission unit 14, received within the transmission case 26 and mainly composed of a single-pinion type first planetary gear set 12; and a second transmission unit 20 of a Ravigneaux type, received within the transmission case 26 and mainly composed of a double-pinion type second planetary gear set 16 and a single-pinion type third planetary gear set 18. The first transmission unit 14 and the second transmission unit 20 are arranged coaxially on a center axis C. The automatic transmission 10 changes the rotational speed of an input shaft 22 and outputs power through an output rotation member 24. The input shaft 22 is an input member and, in the present embodiment, refers to a turbine shaft of a torque converter 32 which is a hydraulic power transmission device rotatingly driven by an engine 30 as a power source for driving the motor vehicle. The output rotation member 24 is an output member in the automatic transmission 10 and functions as an output gear, i.e., a differential drive gear, that meshes with a differential driven gear (large diameter gear) 42 to transfer power to a differential gear unit 40 illustrated in FIG. 3. The output power of the engine 30 is transmitted to a pair of drive wheels 46 via the torque converter 32, the automatic transmission 10, the differential gear unit 40 and a pair of axles 44 (see FIG. 3). Because the automatic transmission 10 and the torque converter 32 are generally symmetrically configured with respect to a center line (center axis) C. In the schematic diagram shown in FIG. 1, halves of them below the center line C are omitted from illustration.

The torque converter 32 is provided with a lock-up clutch 34 as a lock-up mechanism that directly transmits the power of the engine 30 to the input shaft 22 without passing through fluid. The lock-up clutch 34 is a hydraulic friction clutch engaged by a pressure difference ΔP between the pressure in an engagement-side oil chamber 36 and the pressure in a release-side oil chamber 38. When the lock-up clutch 34 is fully engaged (locked up), the power of the engine 30 is directly transmitted to the input shaft 22. The pressure difference ΔP, i.e., a torque capacity, is feedback controlled so that the lock-up clutch 34 can be engaged in a predetermined slipping state. Specifically, when a motor vehicle is driven (if power is on), the turbine shaft (input shaft 22) is caused to rotate dependent upon rotation of the output rotation member of the engine 30 in a predetermined slip amount of, e.g., about 50 rpm. On the other hand, when a motor vehicle is not driven (if power is off), the output rotation member of the engine 30 is caused to rotate dependent upon rotation of the turbine shaft in a predetermined slip amount of, e.g., about −50 rpm.

Depending on different combinations of engaging states of respective rotating elements (sun gears S1-S3, carriers CA1-CA3, ring gears R1-R3) in the first transmission unit 14 and the second transmission unit 20, the automatic transmission 10 establishes six forward drive gears, i.e., first to sixth speed ratios “1st”-“6th”, and one reverse drive gear, i.e., a reverse speed ratio “R”. Referring to FIG. 2, for instance, in the forward drive gears, the first speed ratio is established by engaging a clutch C1 and a brake B2, the second speed ratio is established by engaging the clutch C1 and a brake B1, the third speed ratio is established by engaging the clutch C1 and a brake B3, the fourth speed ratio is established by engaging the clutch C1 and a clutch C2, the fifth speed ratio is established by engaging the clutch C2 and the brake B3, and the sixth speed ratio is established by engaging the clutch C2 and the brake B1. Furthermore, the reverse speed ratio is established by engaging the brake B2 and the brake B3, and a neutral state is achieved by releasing the clutches C1 and C2 and the brakes B1-B3 in their entirety.

The operation table illustrated in FIG. 2 indicates the relationship between the respective speed ratios and the operation states of the clutches C1 and C2 and the brakes B1-B3, in the symbol “◯” (a single circle) represents an engagement operation and the symbol “a double circle” stands for an engagement operation carried out only when an engine brake is applied. Particularly, because a one-way clutch F1 is provided in parallel with the brake B2 for establishing the first speed ratio “1st”, the clutch C1 alone is engaged at the time of start (acceleration) but both the clutch C1 and the brake B2 are engaged when the engine brake is applied. Thus, by bringing the clutch C1 into a slipping state or a released state when stopping the vehicle in first gear, it allows the execution of a “neutral control”, which reduces the idling load of the engine 30. The speed ratios in the respective drive gear stages is properly determined by individual gear ratios (the teeth number of a sun gear/the teeth number of a ring gear) ρ1, ρ2 and ρ3 of the first planetary gear set 12, the second planetary gear set 16 and the third planetary gear set 18.

The clutches C1 and C2 and the brakes B1-B3 (hereinafter simply referred to as “clutches C” and “brakes B”, unless specifically stated otherwise) are hydraulically actuated friction-coupling elements (hydraulically actuated friction-coupling devices), such as multi-disc clutches and multi-disc brakes, whose engagement is controlled by hydraulic actuators. The clutches C and the brakes B are engaged and released by energizing or de-energizing linear solenoid valves SL1-SL5 of a hydraulic control circuit 50 (see FIG. 3) or by controlling an electric current fed to the linear solenoid valves SL1-SL5. A transient fluid pressure during engaging and releasing operations is also controlled in a similar manner.

FIG. 3 is a block diagram showing major parts of the control system provided in a motor vehicle for controlling the automatic transmission 10 shown in FIG. 1 and a simplified configuration of a power transmission system extending from the engine 30 to drive wheels 46.

Referring to FIG. 3, an electronic control unit 100 is comprised of a so-called microcomputer including, e.g., a CPU, a RAM, a ROM and an input/output interface. Using a temporary memory function of the RAM and according to a program pre-stored in the ROM, the CPU processes signals to execute output control of the engine 30, shift control of the automatic transmission 10 and engagement control of the lock-up clutch 34. If needed, the CPU may be divided into an engine control CPU, a shift control CPU for controlling the linear solenoid valves SL1-SL5, a lock-up clutch control CPU for controlling linear solenoid valves SLU and solenoid valves SL of the hydraulic control circuit 50, and the like.

The electronic control unit 100 receives, e.g., an accelerator opening degree signal that indicates the accelerator opening degree A_{CC}, i.e., a depression amount of an 20 accelerator pedal 52 detected by an accelerator opening degree sensor 54; a signal that indicates the engine rotation speed N_{E}, i.e., a rotation speed of the engine 30 detected by an engine rotation speed sensor 56; a signal that indicates the cooling water temperature T_{W} of the engine 30 detected by a cooling water temperature sensor 58; a signal that indicates the intake air quantity Q of the engine 30 detected by an intake air quantity sensor 60; a signal that indicates the intake air temperature T_{A} detected by an intake air temperature sensor 62; a throttle opening degree signal that indicates the opening degree θ_{TH} of an electronic throttle valve detected by a throttle valve opening degree sensor 64; a vehicle speed signal that indicates the rotation speed N_{OUT} of the output rotation member 24, i.e., a vehicle speed V detected by a vehicle speed sensor 66; a signal that indicates the operation (on-condition) B_{ON} of a foot brake pedal 68, i.e., an operation (depression) of a typically available foot brake (wheel brake) detected by a brake switch 70; a signal that indicates the lever position (an operative position or a shift position) P_{SH} of a shift lever 72 detected by a lever position sensor 74; a signal that indicates the turbine rotation speed N_{T} (a rotation speed N_{IN} of the input shaft 22) detected by a turbine rotation speed sensor 76; and a signal that indicates the automatic transmission oil temperature T_{OIL}, i.e., a temperature of working oil within the hydraulic control circuit 50 detected by an automatic transmission oil temperature sensor 78.

The electronic control unit 100 issues a drive signal that is fed to a throttle actuator that controls the opening degree θ_{TH} of the electronic throttle valve; an ignition signal for designating the ignition timing of the engine 30; a fuel supply quantity signal to control the fuel quantity supplied to the engine 30 by a fuel injection device that supplies fuel into an intake manifold or a cylinder of the engine 30 [this is implicit in controlling the fuel quantity]; a lever position (P_{SH}) indication signal that operates a shift indicator; a signal for controlling shift solenoids that operate the shift valves within the hydraulic control circuit 50 to change the speed ratios of the automatic transmission 10; a command signal that operates linear solenoid valves that control a line pressure to change the speed ratios of the automatic transmission 10; a command signal that operates a linear solenoid valve that controls an engaging operation; a releasing operation and a slip amount of the lock-up clutch 34; and other signals.

In response to the operation of the foot brake pedal 68 or other situations, a wheel brake device 80 illustrated in FIG. 3 supplies a brake fluid pressure to wheel cylinders WC (not shown) provided in wheel brakes. Normally, the wheel brake device 80 ensures that a brake fluid pressure generated in a master cylinder in a magnitude corresponding to a depression amount of the foot brake pedal 68 is directly supplied to the wheel cylinders WC. However, in case of performing, e.g., anti-lock brake system (ABS) control, traction control, vehicle stability control (VSC), or a hill hold control for holding a motor vehicle against movement on a hill independently of an operation of the foot brake pedal 68, a brake fluid pressure that does not correspond to the depression amount of the foot brake pedal 68 is supplied to the wheel cylinders WC in order to permit braking, take-off and turning of the motor vehicle on a gently sloping road (i.e., low μ road) or to keep the motor vehicle from moving when on a hill.

A shift lever 72 is provided in, e.g., the vicinity of a driver's seat and, as illustrated in FIG. 3, is manually operated to assume one of five lever positions “P”, “R”, “N”, “D” and “S”.

The “P”-position is a parking position wherein the power transmission path in the automatic transmission 10 is interrupted to achieve a neutral state that disconnects power transfer in the automatic transmission 10, while allowing a mechanical parking mechanism to mechanically hold (or lock) the output rotation member 24 against rotation. The “R”-position is a reverse drive position for reversing a rotational direction of the output rotation member 24 of the automatic transmission 10. The “N”-position is a neutral position for achieving a neutral state that disconnects power transfer in the automatic transmission 10. The “D”-position is a forward drive position wherein automatic shift control is executed over the entire forward drive gear stages, i.e., the first through sixth speed ratios 1st-6ST, in a shift range (D-range) permitting a shifting operation of the automatic transmission 10. The “S”-position is a forward drive position wherein a manual shifting operation between the shift ranges is possible, each of which differently restricts a variability region of speed ratios, i.e., by converting different kinds of shift ranges whose higher speed ratios differ from one another.

The “S”-position has a “+”-position that serves as a lever position P_{SH} for up-shifting the shift range for each operation of the shift lever 72 and a “−”-position that serves as a lever position P_{SH} for down-shifting the shift range for each operation of the shift lever 72. For example, in the “S”-position, one of “6”-range through “L”-range is changed as the shift lever 72 is moved into the “+”-position or the “−”-position. The “L”-range in the “S”-position is an engine brake range in which an enhanced engine brake effect may be attained by engaging the brake B2 at the first speed ratio 1st.

The “D”-position is a lever position for selecting an automatic shift mode, namely, a control mode in which the automatic transmission 10 is able to perform a shifting operation, i.e., automatic shift control over the first through sixth speed ratios as illustrated in FIG. 2. The “S”-position is a lever position for selecting a manual shift mode, namely, a control mode in which automatic shift control is performed within an extent that does not exceed the highest speed ratio restricted in the respective shift ranges of the automatic transmission 10, while performing manual shift control based on the shift range (i.e., the highest speed ratio) which has been changed by a manual operation of the shift lever 72.

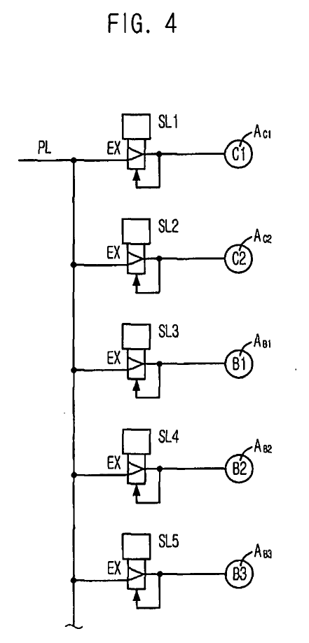

FIG. 4 is a circuit diagram that shows the linear solenoid valves SL1-SL5 that control the operations of individual hydraulic actuators (hydraulic cylinders) A_{C1}, A_{C2}, A_{B1}, A_{B2} and A_{B3} of the clutches C1 and C2 and the brakes B1-B3 in the hydraulic control circuit 50.

Referring to FIG. 4, a line pressure PL is regulated by the respective linear solenoid valves SL1-SL5 into engagement pressures P_{C1}, P_{C2}, P_{B1}, P_{B2} and P_{B3} in accordance with the command signals fed from the electronic control unit 100, and the engagement pressures P_{C1}, P_{C2}, P_{B1}, P_{B2} and P_{B3} thus produced are directly supplied to the respective hydraulic actuators A_{C1}, A_{C2}, A_{B1}, A_{B2} and A_{B3}. A fluid pressure generated from a mechanical oil pump 28 (see FIG. 1), rotatingly driven by the engine 30, is used as a source pressure of the line pressure PL, and is regulated by means of, e.g., a relief-type regulator valve (not shown) into the line pressure PL whose value corresponds to an engine load or the like represented by the accelerator opening degree or the throttle opening degree.

The linear solenoid valves SL1-SL5 each have essentially the same configuration and are independently energized or de-energized by means of the electronic control unit 100. Thus, the pressures in the respective hydraulic actuators A_{C1}, A_{C2}, A_{B1}, A_{B2} and A_{B3} are independently regulated to control the engagement pressures P_{C1}, P_{C2}, P_{B1}, P_{B2} and P_{B3} of the clutches C1 and C2 and the brakes. The automatic transmission 10 establishes the respective speed ratios by, e.g., engaging the predetermined coupling elements as illustrated in the operation table of FIG. 2. Furthermore, a so-called clutch-to-clutch shifting operation that simultaneously controls the release and engagement of the clutches C and the brakes B involved in the shifting operation is performed in the shift control of the automatic transmission 10. For example, in an up-shift from the third speed ratio to the fourth speed ratio illustrated in FIG. 2, the clutch C2 is engaged simultaneously with release of the brake B3, and the transient fluid pressures when releasing the brake B3 and engaging the clutch C2 are suitably controlled to thereby suppress generation of a shift shock.

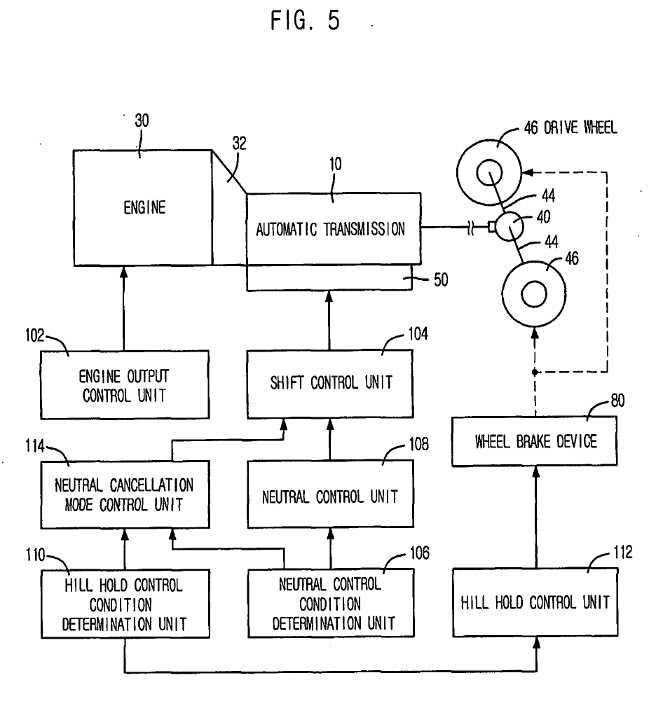

FIG. 5 is a functional block diagram illustrating major function parts controlled by the electronic control unit 100. Referring to FIG. 5, an engine output control unit 102 controls the output of the engine 30 by, e.g., executing a throttle control by controlling the opening and closing of the electronic throttle valve by the throttle actuator, executing a fuel injection control by controlling the fuel injection performed by the fuel injection device, and executing an ignition timing control by controlling the ignition timing of an ignition device, such as an igniter. For example, in accordance with a pre-stored relationship, the engine output control unit 102 operates the throttle actuator based on the signal indicating the accelerator opening degree A_{CC} and performs the throttle control in such a manner that the throttle valve opening degree θ_{TH} increases with increases in the accelerator opening degree signal A_{CC}.

Furthermore, the engine output control unit 102 executes the throttle control in such a manner that an idle rotation speed N_{IDL} is controlled to reach a target value when the motor vehicle stops or decelerates, during which the accelerator opening degree A_{CC} becomes nearly zero (fully closed). For example, in accordance with a pre-stored relationship, the engine output control unit 102 performs the throttle control based on the signal indicating the engine cooling water temperature T_{W} or a signal indicating a catalyst temperature, in such a manner as to achieve a fast idle rotation speed N_{IDLF} greater than a normal post-warm-up idle rotation speed N_{IDL} and then achieve the normal idle rotation speed N_{IDL} upon completion of a warm-up operation.

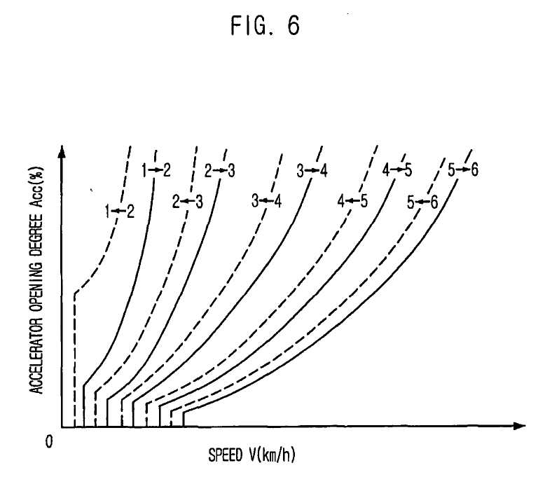

In accordance with a pre-stored relationship (map or shift diagram) between variables, e.g., the vehicle speed V and the accelerator opening degree A_{CC}, as illustrated in FIG. 6, a shift control unit 104 makes shift determination based on the actual vehicle speed V and the actual accelerator opening degree A_{CC}. Specifically, the shift control unit 104 determines whether to shift the automatic transmission 10, and may also determine the speed ratio to be established in the automatic transmission 10, and performs automatic shift control for the automatic transmission 10 to achieve the determined speed ratio. At this time, the shift control unit 104 feeds a command to the hydraulic control circuit 50, wherein the command (shift output or hydraulic command) is used for engaging and/or releasing the hydraulically actuated friction-coupling devices involved in the shifting operation of the automatic transmission 10 to achieve one of the speed ratios shown in the operation table of FIG. 2.

In order for the automatic transmission 10 to perform a shift in response to this command, the hydraulic control circuit 50 energizes the linear solenoid valves SL1-SL5 thereof to thereby operate the hydraulic actuators A_{C1}, A_{C2}, A_{B1}, A_{B2} and A_{B3} of the hydraulically actuated friction-coupling devices.

In the shift diagram shown in FIG. 6, the solid lines indicate shift lines (up-shift lines) for determination of execution of up-shifts and the broken lines indicate shift lines (down-shift lines) for determination of a down-shift (down-shift lines) for determination of execution of down-shifts. The shift lines in the shift diagram shown in FIG. 6 are used to determine whether the actual vehicle speed V intersects a horizontal line representing the actual accelerator opening degree A_{CC} (%), i.e., whether the actual vehicle speed V has gone over one of shift-requiring values (shift-point vehicle speeds) V_{S} on each shift lines. The shift lines are pre-stored as a concatenation of the shift-requiring values, i.e., the shift-point vehicle speeds V_{S}.

A neutral control condition determination unit 106 determines whether predetermined neutral control conditions are satisfied when the shift lever 72 is in the drive position. Examples of the predetermined neutral control conditions include stopping the motor vehicle and depressing the foot brake pedal 68 with the release of the accelerator pedal 52. More specifically, the neutral control condition determination unit 106 determines that the neutral control conditions are satisfied the vehicle speed V is equal to or smaller than a predetermined stop-judgment value and the brake switch 70 is on (B_{ON}) when the lever position P_{SH} being the “D”-position.

Moreover, the neutral control condition determination unit 106 serves as a neutral control release determination unit that sequentially determines whether to terminate neutral control by determining whether the predetermined neutral control conditions remain satisfied during execution of the neutral control by a neutral control unit 108 described below. Specifically, the neutral control condition determination unit 106 will terminate the neutral control, if, during execution of the neutral control, the lever position P_{SH} is changed from the “D”-position to other positions, or the accelerator opening degree grows equal to or greater than a predetermined threshold value, which indicates depression of the accelerator pedal 52, or the brake switch 70 is not on (B_{ON}).

If the neutral control condition determination unit 106 determines that the predetermined neutral control conditions are satisfied when the shift lever 72 is in e.g., the “D”-position, the neutral control unit 108 executes the neutral control to bring the clutch C1, which is a coupling device that is engaged to achieve the first speed ratio, into a slipping condition or a released condition by sending a neutral command to the shift control unit 104. Thus, power transmission in the power transmission path, including the automatic transmission 10, is suppressed or interrupted (or released). In response to the neutral command, the shift control unit 104 feeds a control signal to the hydraulic control circuit 50, wherein the control signal reduces the engagement pressure of the clutch C1 in a predetermined pattern to thereby bring the clutch C1 into the slipping condition or the released condition. Suppression or interruption (release) of the power transfer in the automatic transmission 10 ensures that the torque converter 32 is rotated substantially as a unit thereby reducing the idling load on the engine 30 and reducing the fuel consumption rate and improving NVH (noise, vibration and harshness) control.

Furthermore, when the neutral control condition determination unit 106 determines that the neutral control should be terminated during execution of the neutral control, the neutral control unit 108 terminates the neutral control by feeding a neutral release command to the shift control unit 104 that permits engagement of the clutch C1 to bring the power transmission path including the automatic transmission 10 into a power transferring state.

As set forth above, according to the neutral control, the clutch C1 is released into an immediately-before-engagement condition, just like an engagement with a little slip, whereby the power transmission path in the automatic transmission 10 is substantially released to thereby achieve a ready-to-take-off condition in which a motor vehicle can be immediately take-off by fully engaging the clutch C1 from the semi-engagement state.

A hill hold control condition determination unit 10 determines whether predetermined hill hold conditions are satisfied when the vehicle is moving on a hill. Examples of the predetermined hill hold conditions include, for example, the motor vehicle being in a stop state, the motor vehicle being stopped on a hill with a slope of equal to or greater than a predetermined value, and the accelerator pedal 52 being not depressed. More specifically, the hill hold control condition determination unit 110 regards the predetermined hill hold conditions as being satisfied, if the vehicle speed V is equal to or smaller than a predetermined threshold speed, if the accelerator pedal 52 has an opening degree equal to or smaller than a predetermined zero opening degree threshold, and if, based on the comparison of the acceleration of the motor vehicle on a level ground road and the actual acceleration or based on a signal fed from a slope sensor, the hill is judged to have a slope equal to or greater than a predetermined value.

Furthermore, the hill hold control condition determination unit 110 serves as a hill hold execution determination unit for determining whether the hill hold control is being executed by the hill hold control unit 112 described below, through determination of satisfaction of the hill hold conditions.

Moreover, the hill hold control condition determination unit 110 serves as a hill hold control release determination unit that determines whether to terminate the hill hold control by sequentially determining satisfaction of the hill hold conditions while the hill hold control is being executed by the hill hold control unit 112 described below. Specifically, the hill hold control condition determination unit 110 terminates the hill hold control if, for example, the accelerator opening degree becomes equal to or greater than a predetermined threshold opening degree, which means the accelerator pedal 52 is depressed.

The hill hold control unit 112 enables the wheel brake device 80 to apply a brake force to the drive wheels 46 when the satisfaction of the predetermined hill hold control conditions is confirmed by the hill hold control condition determination unit 1 10 when the vehicle is moving on a hill. Thus, the motor vehicle is held against movement on a hill, e.g., backward movement on an uphill or forward movement on a downhill.

If the hill hold control condition determination unit 110 determines that the hill hold control should be released during execution of the hill hold control (or under the hill hold control), the hill hold control unit 112 releases or terminates the hill hold control by allowing the wheel brake device 80 to remove the brake force from the drive wheels 46.

In the meantime, when the neutral control is released so that the vehicle can move, the drive wheels 46 can be rotated upon full engagement of the clutch C1, insofar as the motor vehicle is in a normal state in which the hill hold control is not executed. This will reduce the torque reaction attributable to the engagement of the clutch C1, thereby suppressing generation of an engagement shock. When releasing the neutral control under the hill hold control, however, the drive wheels 46 are not allowed to rotate at the moment of full engagement of the clutch C1. In that case, the torque reaction attributable to the engagement of the clutch C1 may not be reduced and the engagement shock may be greater than that generated in the normal state. Moreover, because the engagement shock greater than that generated in the normal state may worsen a drive feel, there is a tendency to avoid execution of the neutral control when the motor vehicle is stopped on a steep uphill with accompanying execution of the hill hold control. However, this does not help to increase a chance of executing the neutral control and reduce the fuel consumption rate.

In view of this, a neutral release mode control unit 114 increases the torque transfer capacity of the clutch C1 when releasing the neutral control under the hill hold control, so that the clutch C1 engages more gently when releasing the neutral control under the hill hold control than when releasing the neutral control alone, to thereby suppress generation of a shock which would be caused by engagement of the clutch C1 in the neutral control release process. In other words, when the neutral control is released under the hill hold control, the neutral release mode control unit 114 always reduces the torque transfer capacity of the clutch C1 when engaging the clutch C1, more than that when releasing the neutral control alone. By suppressing generation of an engagement shock and improving a drive feel in this way, it is possible to execute the neutral control with an increased chance of execution and to reduce the fuel consumption rate, even under a running state accompanying the hill hold control in which deterioration of a drive feel is likely to occur and thus there is a tendency to avoid the neutral control for that reason.

Specifically, when the neutral control condition determination unit 106 determines that the neutral control should be released during execution of the neutral control by the neutral control unit 108, the neutral release mode control unit 114 sends a clutch engagement command to the shift control unit 104 to gradually increase the torque transfer capacity of the clutch C1 to engage the clutch C1. At the same time, the hill hold control condition determination unit 110 determines that the hill hold control is being executed by the hill hold control unit 112, the neutral release mode control unit 114 also sends an increment gradient mitigation command to the shift control unit 104 during the process of gradually increasing the torque transfer capacity of the clutch C1, thereby mitigating the increment gradient of the torque transfer capacity so that the torque transfer capacity in the engagement process of the clutch C1 is gradually increased with a smaller value than that when the hill hold control is not executed.

If the neutral release mode control unit 114 sends the increment gradient mitigation command when engaging the clutch C1 in response to the clutch engagement command from the neutral release mode control unit 114, the shift control unit 104 feeds to the hydraulic control circuit 50 a control signal to increase the engagement pressure of the clutch C1 according to a predetermined pattern, so that the engagement pressure is gradually increased with a smaller value than in a predetermined engagement pressure increasing pattern of a control signal that is sent to the hydraulic control circuit 50 without the increment gradient mitigation command supplied from the neutral release mode control unit 114. Therefore, it possible to release the neutral control and suppress an engagement shock that would be generated when the neutral control is released.

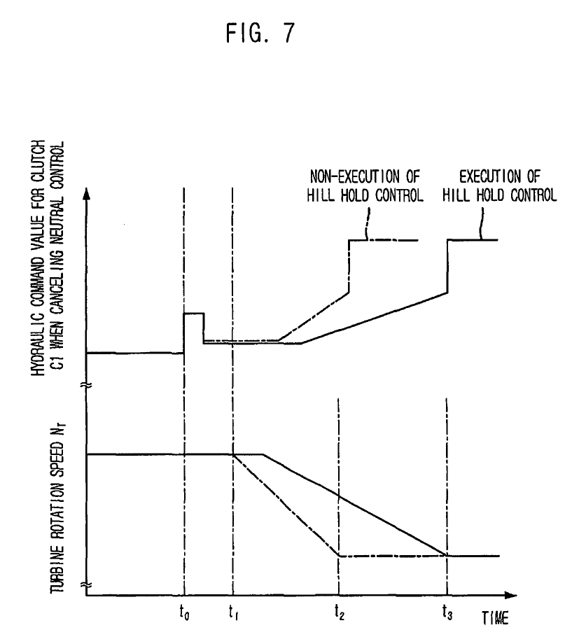

FIG. 7 illustrates one example of a predetermined pattern of control signals (hydraulic command values) that the shift control unit 104 feeds to the hydraulic control circuit 50 to increase the clutch engagement pressure when the clutch C1 is engaged to release the neutral control according to the clutch engagement command of the neutral release mode control unit 114. In this figure, the single-dotted chain line represents a predetermined signal pattern used when the hill hold control unit 112 does not execute the hill hold control and the solid line indicates a predetermined signal pattern used when the hill hold control is being executed by the hill hold control unit 112.

As illustrated in FIG. 7, the hydraulic command values for expedited filling of fluid are all equal at time to when the control signals are initially output. In contrast, once the turbine rotation speed N_{T} begins to decrease with initial build-up of the torque transfer capacity, the hydraulic command values show a change in their increment gradients in such a manner that the increment gradient of the torque transfer capacity under the hill hold control becomes smaller than that without the hill hold control The increment gradients of the hydraulic command values are set such that, for example, the time period between time t₁ and time t₂ is twice as great as the time period between time t₁ and time t₃. Although the hydraulic command values indicated by the solid line and the single-dotted chain line are pre-set in the present embodiment in such a manner that the corresponding turbine rotation speeds N_{T} are gradually reduced with predetermined gradients, it may be possible to feedback control the hydraulic command values so that the turbine rotation speeds N_{T} are gradually reduced with the predetermined gradients.

If the hill hold control is terminated, the neutral release mode control unit 114 increases the torque transfer capacity of the clutch so that the clutch may be engaged more rapidly when the neutral control is released under the hill hold control, thereby making it easy to obtain a drive torque and relieving an unintentional behavior of a motor vehicle which would occur as the hill hold control is terminated.

Specifically, if, during the process of releasing the neutral control, the hill hold control condition determination unit 110 determines that the hill hold control unit 112 has released the hill hold control, the neutral release mode control unit 114 feeds a mitigation withdrawal command to the shift control unit 104 instead of the increment gradient mitigation command issued under the hill hold control, whereby the increment gradient of the torque transfer capacity in the process of gradually increasing the torque transfer capacity of the clutch C1 becomes greater than the increment gradient under the hill hold control. Therefore, it possible to effectively suppress or relieve an unintentional behavior of a motor vehicle which would occur as the hill hold control is terminated during the course of releasing the neutral control. For example, the increment gradient of the torque transfer capacity in case of the hill hold control being terminated during the course of releasing the neutral control grows equal to the increment gradient available at the time of non-execution of the hill hold control or has a median value of the increment gradient under the hill hold control and the increment gradient during non-execution of the hill hold control.

In response to the mitigation withdrawal command from the neutral release mode control unit 114, the shift control unit 104 feeds to the hydraulic control circuit 50 a control signal for increasing the engagement pressure of the clutch C1 according to a predetermined pattern that is different from the predetermined pattern applied under the hill hold control, so that the engagement pressure is gradually increased with a greater value than under the hill hold control.

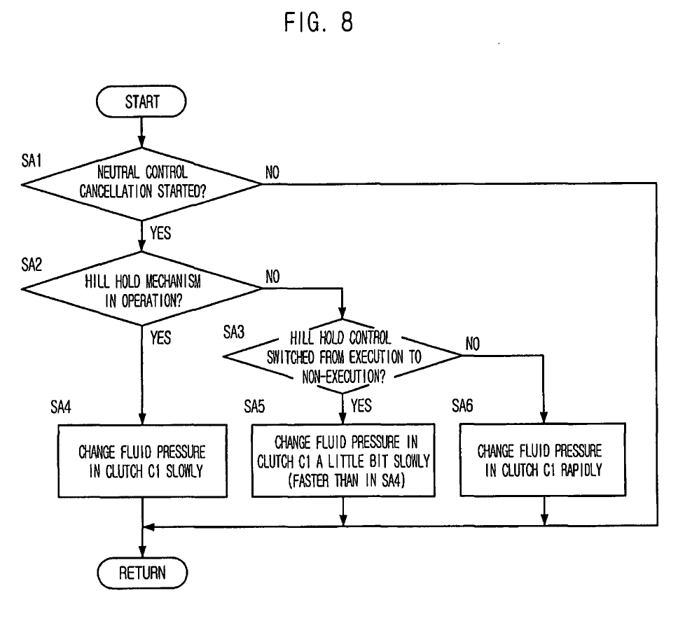

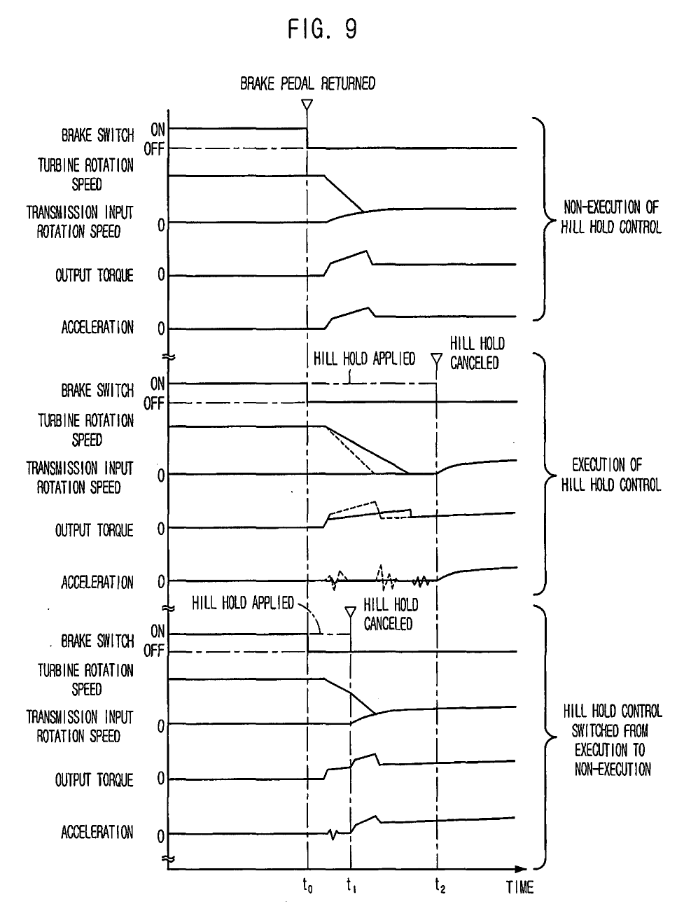

FIG. 8 is a flowchart explaining major control operations of the electronic control unit 100, i.e., control operations for suppressing generation of a shock caused by engagement of the clutch C1 when the neutral control is released. This control operation is repeatedly performed with an extremely short cycle time of, e.g., several milliseconds to several tens of milliseconds. FIG. 9 is a timing chart explaining the control operations illustrated in the flowchart of FIG. 8.

Referring to FIG. 8, in step SA1 (the term “step” will be omitted hereinafter for the sake of convenience), corresponding to the neutral control condition determination unit 106, it is first determined whether the predetermined neutral control conditions are satisfied, thereby determining release or continuation of the neutral control, i.e., the necessity for starting release of the neutral control.

The routine ends if the determination in SA1 is negative. However, if the determination is affirmative, it is determined in SA2, corresponding to the hill hold control condition determination unit 110, whether the hill hold control conditions are satisfied to thereby determine whether the hill hold control is being executed.

At time t₀ in FIG. 9, the foot brake pedal 68 is returned to an original position and, therefore, the brake switch 70 is not turned on (B_{ON}), thus allowing release of the neutral control to be started.

If the determination in SA2 is negative, it is determined in SA3, corresponding to the hill hold control condition determination unit 110, whether the predetermined hill hold control conditions remain satisfied during the hill hold control and, hence, as to whether the hill hold control has been released. In other words, it is determined whether the execution of the hill hold control currently available in a motor vehicle is due to the release of the hill hold control which was in an execution condition just before.

If the determination in SA2 is affirmative, it means that the neutral control is released under the hill hold control. Thus, in SA4, corresponding to the neutral control unit 108 and the neutral release mode control unit 114, the shift control unit 104 is supplied with an increment gradient mitigation command for mitigating the increment gradient of the torque transfer capacity so that the torque transfer capacity in the engagement process of the clutch C1 is gradually increased with a smaller value than in case of non-execution of the hill hold control (SA6 described hereinafter). Therefore, the fluid pressure in the clutch C1 changes (gradually increased) slowly as compared to the case of non-execution of the hill hold control.

Referring to an example regarding execution of the hill hold control, which is illustrated in the middle part in FIG. 9, the neutral control is released during the time period between time t₀ and time t₂ where the hill hold control is released. Thus, the increment gradient of the torque transfer capacity in the engagement process of the clutch C1 becomes relatively small, which means that the turbine rotation speed N_{T} is gradually decreased at a relatively low speed as indicated by the solid line. The output torque (of the automatic transmission 10) and the acceleration change in the manner as indicated by the solid line. The broken lines show a prior art example in which the increment gradient of the torque transfer capacity in the engagement process of the clutch C1 does not become smaller and the turbine rotation speed N_{T} is gradually decreased at a relatively high speed. In the prior art example, the output torque and the acceleration are changed in the manner as indicated by the broken line. As compared to the prior art example, the present embodiment mitigates the change in output torque and acceleration as indicated by the solid line, thereby suppressing generation of a shock. In FIG. 9, the term “transmission input rotation speed” refers to the rotation speed of the sun gear S3 of the automatic transmission 10 (the third planetary gear set 18).

If the determination in SA3 is affirmative, it means that the hill hold control is terminated during release of the neutral control. Thus, in SA5, corresponding to the neutral control unit 108 and the neutral release mode control unit 114, the shift control unit 104 is supplied with a mitigation withdrawal command, instead of the increment gradient mitigation command issued in SA4, for making the increment gradient of the torque transfer capacity in the engagement process of the clutch C1 equal to the increment gradient available in case of non-execution of the hill hold control. Therefore, the fluid pressure in the clutch C1 is gradually increased a little bit slowly. In other words, the fluid pressure in the clutch C1 is changed (gradually increased) a little bit fast as compared to the case of the hill hold control.

Referring now to another example regarding conversion of the hill hold control from execution to non-execution, which is illustrated in the lower part in FIG. 9, the hill hold control is released at time t₁ where the neutral control is being released. Thus, the increment gradient of the torque transfer capacity in the engagement process of the clutch C1 is kept relatively small until time t₁. However, the increment gradient becomes relatively great from time t₁ and, therefore, the turbine rotation speed N_{T} is gradually decreased at a relatively high speed. As a result, the clutch engagement time is shortened as compared to the case where the increment gradient of the torque transfer capacity in the engagement process of the clutch C1 is not made great at time t₁. This makes it easy to obtain a required start torque.

If the determination in SA3 is negative, it means that the neutral control is released when the hill hold control is not executed. Thus, in SA6 a neutral release command is sent to the shift control unit 104 to engage the clutch C1 and thereby bring the power transmission path including the automatic transmission 10 into a condition for power transfer. Therefore, the fluid pressure in the clutch C1 is changed (gradually increased) fast, thus achieving a ready-for-take-off condition that allows a motor vehicle to start moving immediately.

Referring to a further another example regarding non-execution of the hill hold control, which is illustrated in the upper part in FIG. 9, the neutral control is released when the hill hold control is not executed. Thus, the increment gradient of the torque transfer capacity as the clutch C1 becomes engaged is relatively great and, therefore, the turbine rotation speed N_{T} is gradually decreased at a relatively high speed. As a result, the clutch is engaged within a relatively short period of time.

As set forth above, the present embodiment ensures that, when releasing the neutral control under the bill hold control, the torque transfer capacity of the clutch C1 is increased by the neutral release mode control unit 114 in such a manner that the clutch C1 is kept in a slipping state or a released state as the neutral control is engaged more gently than when releasing the neutral control alone. This helps to suppress generation of a shock, which would be caused by the engagement of the clutch C1 when releasing the neutral control under the hill hold control.

Furthermore, a drive feel can be improved by suppressing generation of a shock in this way. Thus, it becomes possible to execute the neutral control with an increased chance of execution and to reduce the fuel consumption rate, even under a running state accompanying the hill hold control, in which deterioration of a drive feel is likely to occur, and thus there is a tendency to avoid the neutral control for that reason, e.g., under a state that a motor vehicle is stopped on a steep uphill with accompanying execution of the hill hold control.

Moreover, the present embodiment ensures that, in the process of gradually increasing the torque transfer capacity of the clutch C1 by the neutral release mode control unit 114, the increment gradient of the torque transfer capacity under the hill hold control becomes smaller than that when the hill hold control is not executed. Thus, the torque transfer capacity in the engagement process of the clutch C1 is gradually increased with a smaller value. This makes it possible to release the neutral control and suppress the generation of an engagement shock when the neutral control is released.

In addition, the present embodiment ensures that, when the hill hold control is being released during the course of releasing the neutral control, the torque transfer capacity of the clutch C1 is increased by the neutral release mode control unit 114 in such a manner that the clutch C1 is engaged more rapidly than when the hill hold control is executed, thereby making it easy to obtain a drive torque and relieving an unintentional behavior of a motor vehicle which may occur when the hill hold control is terminated. Thus, as compared to a case that the clutch C1 is not rapidly engaged, it is easy to obtain a required start torque, while relieving an unintentional behavior of a motor vehicle which would occur as the hill hold control is brought into a non-executed condition. In other words, it is possible to effectively suppress or relieve the behavior of a motor vehicle which would be caused by a change when the hill hold control is converted from execution to non-execution.

Moreover, the present embodiment ensures that, when the hill hold control is terminated during the course of releasing the neutral control, the torque transfer capacity is changed by altering the increment gradient of the torque transfer capacity in the process of gradually increasing the torque transfer capacity of the clutch C1 by the neutral release mode control unit 114. Thus, the torque transfer capacity in the engagement process of the clutch C1 may be gradually increased with a smaller value than in case of non-execution of the hill hold control. This makes it possible to release the neutral control and suppression of an engagement shock that may be generated when the neutral control is released.

Furthermore, the present embodiment ensures that, in case of the hill hold control being switched into non-execution of the hill hold control during the course of releasing the neutral control, the increment gradient of the torque transfer capacity in the process of gradually increasing the torque transfer capacity of the clutch C1 by the neutral release mode control unit 114 becomes equal to the increment gradient available when the hill hold control is not executed. Thus, the torque transfer capacity in the engagement process of the clutch C1 is rapidly increased to thereby assure rapid engagement of the clutch C1, and the torque transfer capacity in the engagement process of the clutch C1 is gradually increased with a smaller value than in case of non-execution of the hill hold control. This makes it possible to release the neutral control and suppress the generation of an engagement shock when the neutral control is released.

In addition, the present embodiment ensures that, when the hill hold control being terminated during the course of releasing the neutral control, the increment gradient of the torque transfer as the torque transfer capacity of the clutch C1 is gradually increased by the neutral release mode control unit 114 has a median value of the increment gradient under the hill hold control and the increment gradient when the hill hold control is not executed. Therefore, it possible to effectively suppress or relieve the behavior of a motor vehicle which would be caused by a change when the hill hold control is terminated.

Next, another embodiment of the present invention will be described. Like reference numerals denote like elements described in embodiments of the present invention and, for the sake of convenience, descriptions for the like elements will be omitted.

With the foregoing embodiment, when the hill hold control is released during the course of releasing the neutral control, the increment gradient of the torque transfer capacity in the engagement process of the clutch C1 is set midway between the increment gradient under the hill hold control and the increment gradient when the hill hold control is not executed. In the present embodiment, however, the increment gradient of the torque transfer capacity in the engagement process of the clutch C1 is changed depending upon whether the hill hold control is being executed during the course of releasing the neutral control.

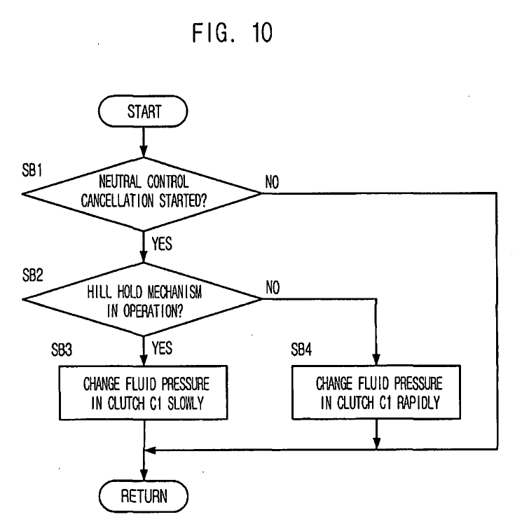

FIG. 10 is a flowchart, which corresponds to FIG. 8 but pertains to a different embodiment, explaining the major control operations of the electronic control unit 100, i.e., control operations for suppressing generation of a shock caused by engagement of the clutch C1 when neutral control is released.

Referring to FIG. 10, in step SB1, corresponding to the neutral control condition determination unit 106, it is first determined whether the predetermined neutral control conditions are satisfied, thereby determining release or continuation of the neutral control, i.e., the necessity for starting release of the neutral control.

The routine ends if the determination in SB1 is negative. However, if the determination is affirmative, satisfaction of the hill hold control conditions is determined in SB2, corresponding to the hill hold control condition determination unit 110, to thereby determine whether the hill hold control is being executed or not.

If the determination in SB2 is affirmative, it means that the neutral control is being released under the hill hold control. Thus, in SB3, corresponding to the neutral control unit 108 and the neutral release mode control unit 114, the shift control unit 104 is supplied with an increment gradient mitigation command for mitigating the increment gradient of the torque transfer capacity so that the torque transfer capacity in the engagement process of the clutch C1 is gradually increased with a smaller value than in case of non-execution of the hill hold control (SB4 described below). Therefore, the fluid pressure in the clutch C1 is changed (gradually increased) slowly as compared to the case of non-execution of the hill hold control.

If the determination in SB2 is negative, it means that the neutral control has been released when the hill hold control is not executed. Thus, in SB4, corresponding to the neutral control unit 108 and the neutral release mode control unit 114, a neutral release command is sent to the shift control unit 104 to engage the clutch C1 so that the power transmission path, including the automatic transmission 10, can transfer power. Therefore, the fluid pressure in the clutch C1 is changed (gradually increased) quickly, thus achieving a ready-to-start condition that allows a motor vehicle to start immediately.

If the determination in SB2 changes from affirmative to negative, it means that the hill hold control was terminated as the neutral control was released. Thus, unlike the above embodiment, in SB4 corresponding to the neutral release mode control unit 114, the shift control unit 104 is supplied with a mitigation withdrawal command, instead of the increment gradient mitigation command issued in SB3, for making the increment gradient of the torque transfer capacity in the engagement process of the clutch C1 equal to the increment gradient available in case of non-execution of the hill hold control. Therefore, the fluid pressure in the clutch C1 is changed (gradually increased) a little bit faster than when the hill hold control is executed.

As described above, the present embodiment ensures that, when the neutral control is released while under the hill hold control, the torque transfer capacity of the clutch C1 is increased by the neutral release mode control unit 114 in such a manner that the clutch C1 kept in a slipping state under the neutral control, or the clutch C1 in a released state under the neutral control, is engaged more gently than when releasing the neutral control when the hill hold control is not executed. This helps to suppress generation of a shock that would be caused by engagement of the clutch C1 when the neutral control is released while under the hill hold control.

Furthermore, a drive feel can be improved by suppressing generation of a shock in this way. Thus, it becomes possible to execute the neutral control with an increased chance of execution and to reduce the fuel consumption rate, even under a running state accompanying the hill hold control in which deterioration of a drive feel is likely to occur and thus there is a tendency to avoid the neutral control for that reason, e.g., when a motor vehicle is stopped on a steep uphill with accompanying execution of the hill hold control.

Moreover, the present embodiment ensures that, in the process of gradually increasing the torque transfer capacity of the clutch C1 by the neutral release mode control unit 114, the increment gradient of the torque transfer capacity under the hill hold control becomes smaller than that when the hill hold control is not executed. Thus, the torque transfer capacity in the engagement process of the clutch C1 is gradually increased with a smaller value. This makes it possible to release the neutral control and suppress the generation of the engagement when the neutral control is released.

In addition, the present embodiment ensures that, if the hill hold control is terminated during the course of releasing the neutral control, the increment gradient of the torque transfer capacity in the process of gradually increasing the torque transfer capacity of the clutch C1 by the neutral release mode control unit 114 becomes equal to the increment gradient available when the hill hold control is not executed. Thus, the torque transfer capacity in the engagement process of the clutch C1 is gradually increased with a smaller value than in case of non-execution of the hill hold control. This makes it possible to release the neutral control and suppress engagement shock, which would be generated when the neutral control is released. Furthermore, as compared to when the clutch C1 is not rapidly engaged, it is easier to obtain a required start torque, while relieving an unintentional behavior of a motor vehicle that would occur when the hill hold control is terminated.

In the second embodiment, when the neutral control is released while under the hill hold control, the neutral release mode control unit 114 increases the torque transfer capacity of the clutch C1 in such a manner that the clutch C1 is gently engaged by reducing the increment gradient of the torque transfer capacity as compared to when the neutral control during the hill hold control is not executed. In the present embodiment, however, the torque transfer capacity of the clutch C1 is increased in such a manner that the clutch C1 is gently engaged by reducing the magnitude of the torque transfer capacity in the process of gradually increasing the torque transfer capacity of the clutch C1. Namely, in the present embodiment, the torque transfer capacity of the clutch C1 is increased in such a fashion that the clutch C1 is gently engaged by changing the absolute value of the torque transfer capacity in the process of gradually increasing the torque transfer capacity of the clutch C1 without changing an increment gradient of torque transfer capacity.

More specifically, when the neutral control condition determination unit 106 determines that the neutral control should be released during execution of the neutral control, the neutral release mode control unit 114 sends a clutch engagement command to the shift control unit 104 for gradually increasing the torque transfer capacity of the clutch C1 to thereby engage the clutch C1, but, if the hill hold control condition determination unit 110 determines that the hill hold control is being executed by the hill hold control unit 112, the neutral release mode control unit 114 sends an engagement pressure reduction command to the shift control unit 104 for, during the process of gradually increasing the torque transfer capacity of the clutch C1, reducing the magnitude of the torque transfer capacity so that the torque transfer capacity in the engagement process of the clutch C1 is gradually increased with a smaller value than in case of determination of non-execution of the hill hold control.

If the engagement pressure reduction command is sent from the neutral release mode control unit 114 when engaging the clutch C1 in response to the clutch engagement command of the neutral release mode control unit 114, the shift control unit 104 sends a control signal to the hydraulic control circuit 50 for increasing an engagement pressure of the clutch C1 according to a predetermined pattern so that the engagement pressure is gradually increased with a value prescribed amount smaller than in a predetermined pressure increasing pattern of a control signal which is sent to the hydraulic control circuit 50 in case of non-supply of the engagement pressure reduction command from the neutral release mode control unit 114. This makes it possible to release the neutral control, i.e., end the neutral control, and suppress engagement shock.

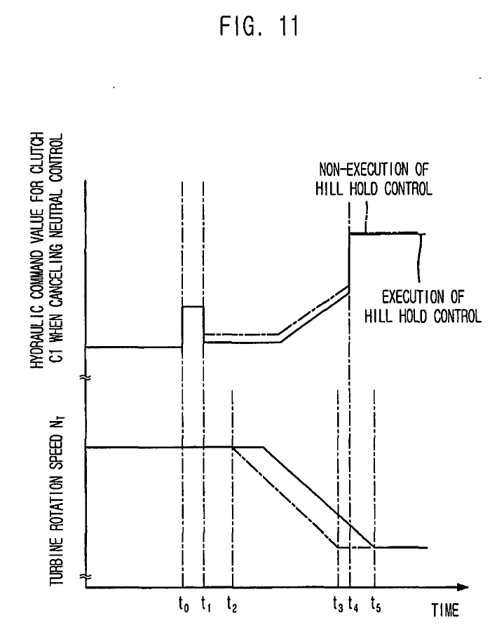

FIG. 11 is a view showing one example of predetermined patterns of control signals (hydraulic command values) that are output to the hydraulic control circuit 50 by means of the shift control unit 104 for increasing the clutch engagement pressure when the clutch C1 is engaged to release the neutral control in response to the clutch engagement command from the neutral release mode control unit 114, the single-dotted chain line represents a predetermined signal pattern when the hill hold control unit 112 does not execute the hill hold control, the solid line indicates a predetermined signal pattern when the hill hold control is being executed by the hill hold control unit 112.

As illustrated in FIG. 11, the hydraulic command values for expedited filling of fluid are equal to each other at time t₀ when the control signals are initially output. Within the span ranging from time t₁ to time t₄, however, the hydraulic command value issued under the hill hold control is reduced by a predetermined amount in a constant manner, so that the absolute value of the torque transfer capacity is reduced. Although the hydraulic command values indicated by the solid line and the single-dotted chain line are pre-set in the present embodiment to ensure that the corresponding turbine rotation speeds N_{T} are gradually reduced with predetermined gradients, it is possible to feedback control the hydraulic command values so that the turbine rotation speeds N_{T} are gradually reduced with the predetermined gradients.

Moreover, if, during the process of releasing the neutral control, the hill hold control condition determination unit 110 determines that the hill hold control unit 112 has released the hill hold control, the neutral release mode control unit 114 sends a reduction withdrawal command to the shift control unit 104 instead of the engagement pressure reduction command issued under the hill hold control, whereby the magnitude of the torque transfer capacity in the process of gradually increasing the torque transfer capacity of the clutch C1 is so changed as to become greater than the magnitude of the torque transfer capacity under the hill hold control. This makes it possible to effectively suppress or relieve an unintentional behavior of a motor vehicle when the hill hold control is terminated during the course of releasing the neutral control. For example, the magnitude of the torque transfer capacity in case of the hill hold control being terminated during the course of releasing the neutral control grows equal to the magnitude available at the time of non-execution of the hill hold control or has a medial value of the magnitude under the hill hold control and the magnitude when the hill hold control is not executed.

In response to the reduction withdrawal command from the neutral release mode control unit 114, the shift control unit 104 feeds to the hydraulic control circuit 50 a control signal for increasing the engagement pressure of the clutch C1 according to a predetermined pattern, instead of the predetermined pattern applied under the hill hold control, so that the engagement pressure is gradually increased with a greater value than under the hill hold control.

As described above, just as in the foregoing embodiments, the present embodiment ensures that, when the neutral control is released while under the hill hold control, the torque transfer capacity of the clutch C1 is gradually increased in such a manner that the magnitude of the torque transfer capacity in the process of gradually increasing the torque transfer capacity of the clutch C1 by the neutral release mode control unit 114 becomes smaller than the magnitude in case of releasing the neutral control when the hill hold control is not executed, whereby the clutch C1 kept in a slipping state or a released state when the neutral control is engaged with a smaller torque transfer capacity. This helps to suppress generation of a shock that would be caused by the engagement of the clutch C1 when releasing the neutral control under the hill hold control, thus releasing the neutral control and suppressing the engagement shock that is usually generated when the neutral control is released.

Furthermore, the drive feel can be improved by suppressing generation of a shock in this way. Thus, it becomes possible to execute the neutral control with an increased chance of execution and to reduce the fuel consumption rate, even under a running state accompanying the hill hold control in which deterioration of a drive feel is likely to occur and thus there is a tendency to avoid the neutral control for that reason, e.g., under a state that a motor vehicle is stopped on a steep uphill with accompanying execution of the hill hold control.

Moreover, the present embodiment ensures that, if the hill hold control is terminated while releasing the neutral control, the torque transfer capacity of the clutch C1 is increased by the neutral release mode control unit 114 in such a manner that the clutch C1 is engaged more rapidly than in case of execution of the hill hold control. Thus, as compared to a case that the clutch C1 is not rapidly engaged, it becomes easy to obtain the required start torque, while relieving an unintentional behavior of a motor vehicle which would occur as the hill hold control ends. In other words, it is possible to effectively suppress or relieve the behavior of a motor vehicle that would be caused when the hill hold control is ended.

In addition, the present embodiment ensures that, if the hill hold control is terminated while releasing the neutral control, the absolute value of the torque transfer capacity of the clutch C1 is changed when the torque transfer capacity is gradually increased by the neutral release mode control unit 114. Thus, the torque transfer capacity as the clutch C1 is engaged can be gradually increased with a smaller value than in case of non-execution of the hill hold control. Therefore, it possible to release the neutral control and suppress engagement shock.

Furthermore, the present embodiment ensures that, if the hill hold control is terminated while releasing the neutral control, the magnitude of the torque transfer capacity of the clutch C1 as the torque transfer capacity is gradually increased by the neutral release mode control unit 114 becomes equal to the magnitude of the torque transfer capacity available when the hill hold control is not executed. Thus, the torque transfer capacity as the clutch C1 is engaged is rapidly increased to assure rapid engagement of the clutch C1, and the torque transfer capacity in the engagement process of the clutch C1 is gradually increased with a smaller value than in case of non-execution of the hill hold control. This makes it possible to release the neutral control and suppress engagement shock.

Furthermore, the present embodiment ensures that, when the hill hold control is terminated when releasing the neutral control, the magnitude of the torque transfer capacity of the clutch C1 when the torque transfer capacity is gradually increased by the neutral release mode control unit 114 is equal to the median value of the magnitude under the hill hold control and the magnitude when the hill hold control is not executed. This makes effectively suppresses or relieves the behavior of a motor vehicle, which would be caused by a change when the hill hold control is converted from execution to non-execution.

While example embodiments of the present invention have been described with reference to the accompanying drawings, the present invention may be embodied in other forms.

For example, unlike the foregoing embodiments wherein the neutral control unit 108 executes the neutral control when the shift lever 72 is in the “D” position, the neutral control may be executed when the shift lever 72 is in the “R” position. In this case, at least one of the brakes B2 and B3, which are coupling devices for achieving the reverse speed ratio, is brought into a slipping state or a released state. The present invention is applicable to such a case that the neutral control is executed in the “R” position.

As a further alternative, the neutral control condition determination unit 106 may determine the start of release of the neutral control, if the clutch C1 reaches or exceeds a temperature at which the durability thereof is lost or if the clutch C1 is kept at that temperature for more than a predetermined period of time. In a similar manner, it may be possible to set a variety of other conditions for determining the start of release of the neutral control. The temperature of the clutch C1 may be directly detected by use of a temperature sensor or may be estimated from the difference of relative rotation speeds of the clutch C1 while in a slipping state or the time period in which slipping occurs consecutively.

Furthermore, unlike the foregoing embodiments in which the hill hold control unit 112 executes the hill hold control by allowing the brake device 80 to apply a brake force on the drive wheels 46, the hill hold control may also be executed when the drive wheels 46 are locked against movement by locking the output rotation member 24 of the automatic transmission 10. The present invention is applicable to such a manner of executing the hill hold control.

While the present invention has been described with respect to certain preferred embodiments, it will be apparent to those skilled in the art that various changes and modifications can be made without departing from the spirit and scope of the invention as defined in the following claims.

What is claimed is:

1. A vehicle start control device for conducting neutral control and hill hold control, wherein, in the neutral control, if predetermined neutral control conditions are satisfied in a drive position, a coupling device provided in a power transmission path between an engine and drive wheels is brought into a slipping state or a released state and thus the power transmission path is kept in a power transfer suppressing state to reduce an engine idling load and, in the hill hold control, if predetermined hill hold control conditions are satisfied on a hill, a brake force is generated in a motor vehicle to hold the motor vehicle against movement on the hill, comprising:
a neutral release mode controller that increases a torque transfer capacity of the coupling device in such a manner that the coupling device is engaged more gently in case of releasing the neutral control under the hill hold control than in case of releasing the neutral control when the hill hold control is not executed.

2. The vehicle start control device according to claim 1, wherein the neutral release mode controller engages the coupling device by gradually increasing a torque transfer capacity of the coupling device, and wherein, in gradually increasing the torque transfer capacity of the coupling device, the neutral release mode controller reduces an increment gradient of the torque transfer capacity under the hill hold control more than that when the hill hold control is not executed.

3. The vehicle start control device according to claim 1, wherein the neutral release mode controller engages the coupling device by gradually increasing a torque transfer capacity of the coupling device, and wherein, in gradually increasing the torque transfer capacity of the coupling device, the neutral release mode controller reduces a magnitude of the torque transfer capacity under the hill hold control more than that when the hill hold control is not executed.

4. The vehicle start control device according to claim 1, wherein the neutral release mode controller increases a torque transfer capacity of the coupling device in such a manner that, when the hill hold control is terminated during the course of releasing the neutral control, the coupling device is engaged more rapidly than in case of the hill hold control.

5. The vehicle start control device according to claim 4, wherein the neutral release mode controller engages the coupling device by gradually increasing the torque transfer capacity of the coupling device, and wherein, in gradually increasing the torque transfer capacity of the coupling device, the neutral release mode controller controls an increment gradient of the torque transfer capacity to be substantially equal to that when the hill hold control is not executed.

6. The vehicle start control device according to claim 4, wherein the neutral release mode controller engages the coupling device by gradually increasing the torque transfer capacity of the coupling device, wherein, in gradually increasing the torque transfer capacity of the coupling device, the neutral release mode controller controls a magnitude of the torque transfer capacity to be substantially equal to that when the hill hold control is not executed.

7. The vehicle start control device according to claim 1, wherein, when the hill hold control is terminated during releasing the neutral control, the neutral release mode controller increases a torque transfer capacity of the coupling device in a different manner from the case of the hill hold control.

8. The vehicle start control device according to claim 7, wherein the neutral release mode controller engages the coupling device by gradually increasing the torque transfer capacity of the coupling device, the neutral release mode controller changes an increment gradient of the torque transfer capacity in gradually increasing the torque transfer capacity of the coupling device.

9. The vehicle start control device according to claim 8, wherein the neutral release mode controller allows the increment gradient of the torque transfer capacity in gradually increasing the torque transfer capacity of the coupling device to have a median value of an increment gradient under the hill hold control and an increment gradient when the hill hold control is not executed.

10. The vehicle start control device according to claim 7, wherein the neutral release mode controller engages the coupling device by gradually increasing the torque transfer capacity of the coupling device, the neutral release mode controller changes a magnitude of the torque transfer capacity in gradually increasing the torque transfer capacity of the coupling device.

11. The vehicle start control device according to claim 10, wherein the neutral release mode controller allows the magnitude of the torque transfer capacity in gradually increasing the torque transfer capacity of the coupling device to have a median value of a magnitude of the torque transfer capacity under the hill hold control and a magnitude of the torque transfer capacity when the hill hold control is not executed.

12. A vehicle start control method for conducting neutral control and hill hold control, wherein, in the neutral control, if predetermined neutral control conditions are satisfied in a drive position, a coupling device provided in a power transmission path between an engine and drive wheels is brought into a slipping state or a released state and thus the power transmission path is kept in a power transfer suppressing state to reduce an engine idling load and, in the hill hold control, if predetermined hill hold control conditions are satisfied on a hill, a brake force is generated in a motor vehicle to hold the motor vehicle against movement on the hill, comprising:
increasing a torque transfer capacity of the coupling device in such a manner that the coupling device is engaged more gently in case of releasing the neutral control under the hill hold control than in case of releasing the neutral control when the hill hold control is not executed.

13. The vehicle start control method according to claim 12, wherein the torque transfer capacity of the coupling device is gradually increased and an increment gradient of the torque transfer capacity under the hill hold control is reduced more than that when the hill hold control is not executed as the torque transfer capacity of the coupling device is gradually increased.

14. The vehicle start control method according to claim 12, wherein the torque transfer capacity of the coupling device is gradually increased and a magnitude of the torque transfer capacity under the hill hold control is reduced more than that when the hill hold control is not executed as the torque transfer capacity of the coupling device is gradually increased.

15. The vehicle start control method according to claim 12, wherein the torque transfer capacity is increased by increasing the torque transfer capacity of the coupling device in such a manner that, when the hill hold control is terminated during releasing the neutral control, the coupling device is engaged more rapidly than in case of the hill hold control.

16. The vehicle start control method according to claim 15, wherein the torque transfer capacity of the coupling device is gradually increased, and an increment gradient of the torque transfer capacity is equal to that when the hill hold control is not executed as the torque transfer capacity of the coupling device is gradually increased.

17. The vehicle start control method according to claim 15, wherein the torque transfer capacity of the coupling device is gradually increased, and a magnitude of the torque transfer capacity is equal to that when the hill hold control is not executed as the torque transfer capacity of the coupling device is gradually increased.

18. The vehicle start control method according to claim 12, wherein the torque transfer capacity of the coupling device is gradually increased and changing an increment gradient of the torque transfer capacity as the torque transfer capacity of the coupling device is gradually increased.

19. The vehicle start control method according to claim 18, wherein, the increment gradient of the torque transfer capacity of the coupling device, as the torque transfer capacity is gradually increased, has a median value of an increment gradient under the hill hold control and an increment gradient when the hill hold control is not executed.

20. The vehicle start control method according to claim 18, wherein the magnitude of the torque transfer capacity of the coupling device, as the torque transfer capacity is gradually increased, has a median value of a magnitude of the torque transfer capacity available under the hill hold control and a magnitude of the torque transfer capacity available when the hill hold control is not executed.
